(19) United States
(12) Patent Application Publication
(10) Pub. No.: US 2006/0055868 A1
(43) Pub. Date: Mar. 16, 2006

(54) Floatable eyeglasses

(76) Inventor: Yu-Shun Lee, Chiayi (TW)

Correspondence Address: GREENBERG TRAURIG LLP, MET LIFE BUILDING, 200 PARK AVENUE; 14TH FLOOR, NEW YORK, NY, 10166, US

(21) Appl. No.: 11/215,337

(22) Filed: Aug. 29, 2005

Related U.S. Application Data
(60) Provisional application No. 60/605,149, filed on Aug. 30, 2004.

(51) Int. Cl. G02C 1/00

(52) U.S. Cl. 351/43

(57) ABSTRACT

The present invention relates to floatable eyeglasses. More particularly, one embodiment of the present invention provides floatable eyeglasses, comprising: a first lens; a second lens; a frame, wherein the first lens and the second lens are mounted to the frame; a left temple arm having at least one cavity therein; a first cover element configured to attach to the left temple arm and cover the cavity in the left temple arm to produce a substantially watertight compartment in the left temple arm; a right temple arm having a cavity therein; and a second cover element configured to attach to the right temple arm and cover the cavity in the right temple arm to produce a substantially watertight compartment in the right temple arm; wherein the left temple arm is attached to a first end of the frame; wherein the right temple arm is attached to a second end of the frame; and wherein the substantially watertight compartment in the left temple arm and the substantially watertight compartment in the right temple arm are sized to provide, in combination, sufficient buoyancy to permit the eyeglasses to float in water. Another embodiment of the present invention provides floatable eyeglasses, comprising: a first lens; a second lens; a frame, wherein the first lens and the second lens are mounted to the frame; a left temple arm having a first portion and a second portion, wherein the first portion has an extension member extending therefrom and the second portion has a cavity therein and wherein the extension member is configured to be received within the cavity such that the first portion and the second portion mate to produce a substantially watertight compartment in the left temple arm; a right temple arm having a first portion and a second portion, wherein the first portion has an extension member extending therefrom and the second portion has a cavity therein and wherein the extension member is configured to be received within the cavity such that the first portion and the second portion mate to produce a substantially watertight compartment in the right temple arm; wherein the left temple arm is attached to a first end of the frame; and wherein the right temple arm is attached to a second end of the frame.

### RELATED APPLICATIONS

This application claims the benefit of U.S. Provisional Application Ser. No. 60/605,149, filed Aug. 30, 2004, incorporated herein by reference in its entirety.

### FIELD OF THE INVENTION

The present invention relates to floatable eyeglasses.

More particularly, one embodiment of the present invention provides floatable eyeglasses, comprising: a first lens; a second lens; a frame, wherein the first lens and the second lens are mounted to the frame; a left temple arm having at least one cavity therein; a first cover element configured to attach to the left temple arm and cover the cavity in the left temple arm to produce a substantially watertight compartment in the left temple arm; a right temple arm having a cavity therein; and a second cover element configured to attach to the right temple arm and cover the cavity in the right temple arm to produce a substantially watertight compartment in the right temple arm; wherein the left temple arm is attached to a first end of the frame; wherein the right temple arm is attached to a second end of the frame; and wherein the substantially watertight compartment in the left temple arm and the substantially watertight compartment in the right temple arm are sized to provide, in combination, sufficient buoyancy to permit the eyeglasses to float in water.

Another embodiment of the present invention provides floatable eyeglasses, comprising: a first lens; a second lens; a frame, wherein the first lens and the second lens are mounted to the frame; a left temple arm having a first portion and a second portion, wherein the first portion has an extension member extending therefrom and the second portion has a cavity therein and wherein the extension member is configured to be received within the cavity such that the first portion and the second portion mate to produce a substantially watertight compartment in the left temple arm; a right temple arm having a first portion and a second portion, wherein the first portion has an extension member extending therefrom and the second portion has a cavity therein and wherein the extension member is configured to be received within the cavity such that the first portion and the second portion mate to produce a substantially watertight compartment in the right temple arm; wherein the left temple arm is attached to a first end of the frame; and wherein the right temple arm is attached to a second end of the frame.

For the purposes of describing and claming the invention, the term “watertight” means that a chamber or the like would be substantially capable of prohibiting water or a similar fluid from entering (absent the application of a pressure above a nominal pressure at which the chamber is designed to perform).

Further, for the purposes of describing and claming the invention, the term “floatable” (or “float”) means that an object has sufficient buoyancy to prohibit sinking of the object. That is, the object will not necessarily ride entirely above the water or similar fluid but, rather, that the object will not sink to the bottom.

### BACKGROUND OF THE INVENTION

Various types of eyeglasses have been proposed. Some of these proposals have even included a mechanism to make the eyeglasses float. Examples include the eyeglasses described in the following U.S. Patents.

U.S. Pat. No. 5,495,303, to Kolentsi, relates to floating eyeglasses having a lateral flange. More particularly, this patent relates to eyeglasses which float and also protect the wearer from the impact of flying object such as hurled pebbles. The eyeglasses of the invention comprise a lens, a frame for holding the lens characterized by a top transverse frame member having an interior side including a lateral flange therealong, temple arms mounted to the frame, and a foam member adhesively bonded to the interior side of the transverse member and partially abutting the flange, the foam member having a buoyancy greater than the weight of the eyewear. The flange is said to prevent the foam strip from being dislodged due to repeated wear and the loss of efficacy of adhesives used to bond the foam strip.

U.S. Pat. No. 6,059,408, to Bonacci, relates to snug fitting floating eyeglasses. More particularly, this patent relates to floating eyeglasses having a frame (20) with lenses (22), a bridge (24) and ends (26), preferably of the wrap around type fabricated of thermoplastic, which are modified to include elements that permit the eyeglasses to float. Temples (30) are pivotally attached to the frame and include a inwardly curved smooth surface (36). A number of frame float pads (38-44) are attached to the frame adjacent to hinges that connect the temples. A pair of temple float pads (52) and (54) are attached to the curved surface of the temples. The combined frame and temple float pads have sufficient buoyancy to overcome the weight of the frame and temples permitting the eyeglasses to float in water with the temples always in an upright position.

U.S. Pat. No. 6,513,925, to Bonacci, also relates to snug fitting floating eyeglasses. More particularly, this patent relates to eyeglasses which fit snugly to a wearers head and consists of a frame (20) with bridge (24) in the middle and a pair of lenses (22), one on each side of the bridge. A pair of side temples (30) each have at a pair of openings (44) therethrough, with the temples inside surface configured with a flat portion (40) and a raised edge (42) that protectively encompasses the flat portion. The outside surface (38) is in a convex outer shape. Hinges connect the temples to the frame permitting them to be folded flat against the frame for ease of handling and storage. A pair of float pads (54) are configured in a recessed inverse image of the opening through each side temple and each float pad is snapped into forced into conformance with the temple opening securing it in place due to the flexibility of the pad. The pads engagement with a wearers head creates a snug fit and the pads buoyancy is sufficient to overcome the combined weight of the frame and temples permitting the eyewear to float in water with the temples protruding vertically above water's surface.

### BRIEF DESCRIPTION OF THE DRAWINGS

FIG. 1 shows a front view of eyeglasses according to an embodiment of the present invention;

FIG. 2 shows a top view of eyeglasses of FIG. 1;

FIG. 3 shows a top view of a left temple of the eyeglasses of FIG. 1;

FIG. 4 shows a side view of the inner side of left temple of FIG. 3;

FIG. 5 shows a side view of the inner side of a part which attaches to the left temple of FIG. 3;

FIG. 6 shows a top view of the part of FIG. 5;

FIG. 7 shows a perspective view of the left temple and part of the front frame of the eyeglasses of FIG. 1;

FIG. 8 shows a front view of eyeglasses according to another embodiment of the present invention;

FIG. 9 shows a top view of the eyeglasses of FIG. 8;

FIG. 10 shows a side view of the inner side of left temple of FIG. 9;

FIG. 11 shows a side view of the inner side of a part which attaches to the left temple of FIG. 9;

FIG. 12 shows a top view of the part of FIG. 11;

FIG. 13 shows a front view of eyeglasses according to another embodiment of the present invention;

FIG. 14 shows a top view of the eyeglasses of FIG. 13;

FIG. 15 shows a side view of the eyeglasses of FIG. 13;

FIG. 15A shows a cross-section taken along line A-A of FIG. 15;

FIG. 15B shows a cross-section taken along line B-B of FIG. 15;

FIG. 16 shows a front view of one of the lenses of the eyeglasses of FIG. 13;

FIG. 17 shows an example air chamber volume;

FIG. 18 shows a top view of temple arm construction according to another embodiment of the present invention;

FIG. 19 shows a side view (outer side) of the temple arm of FIG. 18;

FIG. 20 shows a top view of a first portion of the temple arm of FIGS. 18 and 19;

FIG. 20A shows a cross-sectional view of the extension member of the first portion of the temple arm of FIGS. 18 and 19;

FIG. 21 shows a side view (outer side) of the first portion of the temple arm of FIGS. 18 and 19;

FIG. 22 shows a top view of a second portion of the temple arm of FIGS. 18 and 19;

FIG. 22A shows a cross-sectional view of the cavity of the second portion of the temple arm of FIGS. 18 and 19;

FIG. 23 shows a side view (outer side) of the second portion of the temple arm of FIGS. 18 and 19; and

FIG. 24 shows a cross-sectional view (taken along line A-A of FIG. 19) showing the fit between the extension member and the cavity.

Among those benefits and improvements that have been disclosed, other objects and advantages of this invention will become apparent from the following description taken in conjunction with the accompanying figures. The figures constitute a part of this specification and include illustrative embodiments of the present invention and illustrate various objects and features thereof.

### DETAILED DESCRIPTION OF THE INVENTION

Detailed embodiments of the present invention are disclosed herein; however, it is to be understood that the disclosed embodiments are merely illustrative of the invention that may be embodied in various forms. In addition, each of the examples given in connection with the various embodiments of the invention are intended to be illustrative, and not restrictive (in this regard, any dimensions provided in any of the figures is, or course, intended to be illustrative and not restrictive). Further, the figures are not necessarily to scale, some features may be exaggerated to show details of particular components. Therefore, specific structural and functional details disclosed herein are not to be interpreted as limiting, but merely as a representative basis for teaching one skilled in the art to variously employ the present invention.

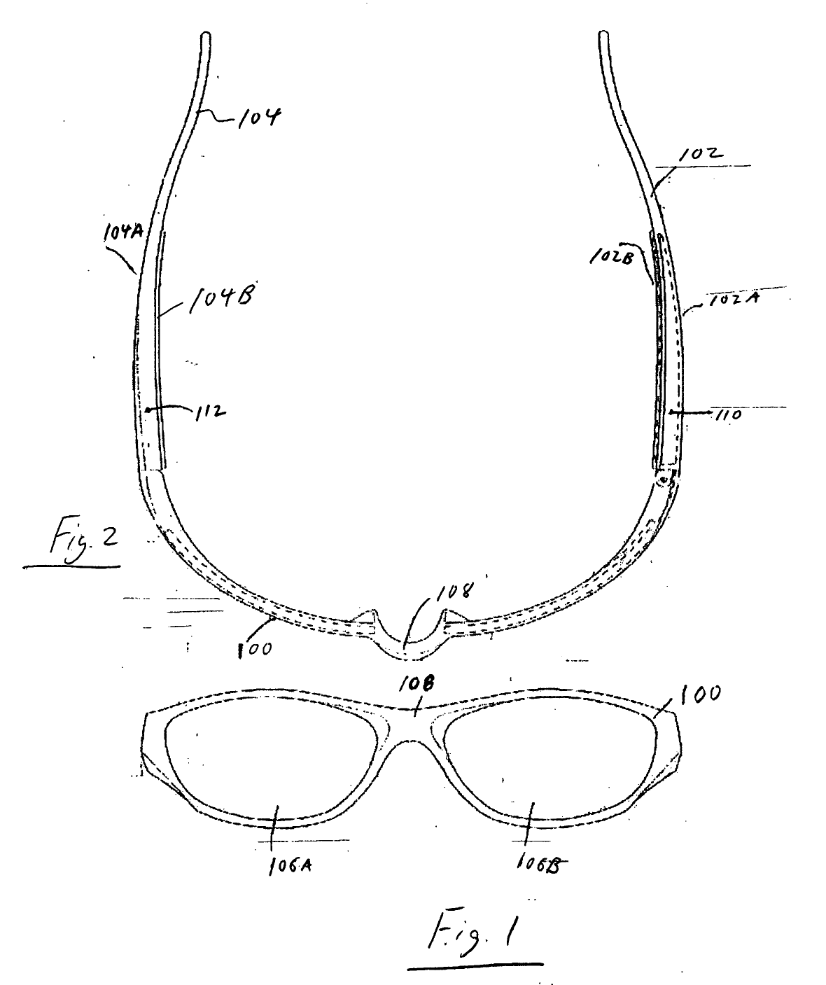

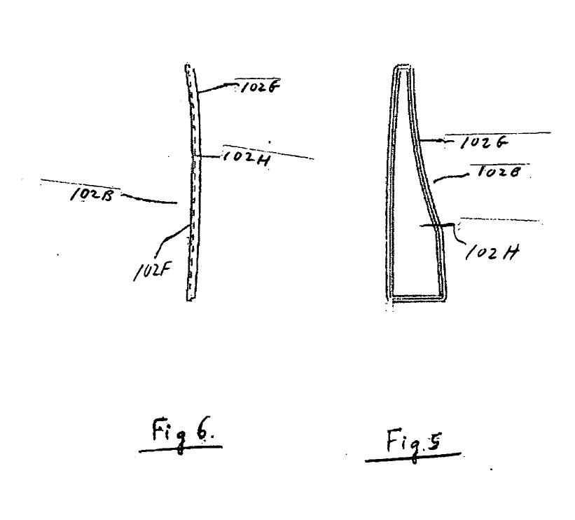

Referring now to FIGS. 1-7, floatable eyeglasses according to one embodiment of the present invention are shown. More particularly, it is seen that the eyeglasses of this embodiment include Front Frame 100, Left Temple Arm 102 and Right Temple Arm 104. Further, Front Frame 100 has attached thereto a pair of Lenses 106A and 106B. Moreover, Front Frame 100 includes Bridge 108, Left Temple Arm 102 includes First Part 102A and Second Part 102B and Right Temple Arm 104 includes First Part 104A and Second Part 104B.

As seen, for example, in FIG. 2, Air Chamber 110 is formed in Left Temple Arm 102 when Second Part 102B is attached to First Part 102A. Likewise, Air Chamber 112 is formed in Right Temple Arm 104 when Second Part 104B is attached to First Part 104A. These air chambers 110 and 112 may operate (either alone or in combination) to provide sufficient buoyancy to permit the eyeglasses to float in water (e.g., “salt” water or “fresh” water).

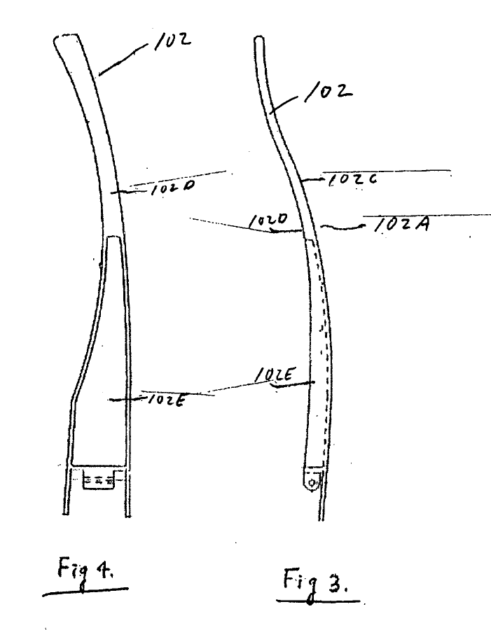

Referring now more particularly to FIGS. 3-6, detail of Left Temple Arm 102 is shown (of course, the two temple arms may be similarly constructed). In any case, it is seen that First Part 102A may include Outer Side 102C, Inner Side 102D and Hollow Area 102E (wherein Hollow Area 102E is sealed by Second Part 102 B to Form Air Chamber 110). Moreover, it is seen that Second Part 102B may include Outer Side 102F, Inner Side 102G and Hollow Area 102H (wherein Hollow Area 102H of Second Part 102B is disposed adjacent Hollow Area 102E of First Part 102A to maximize the volume of Air Chamber 110).

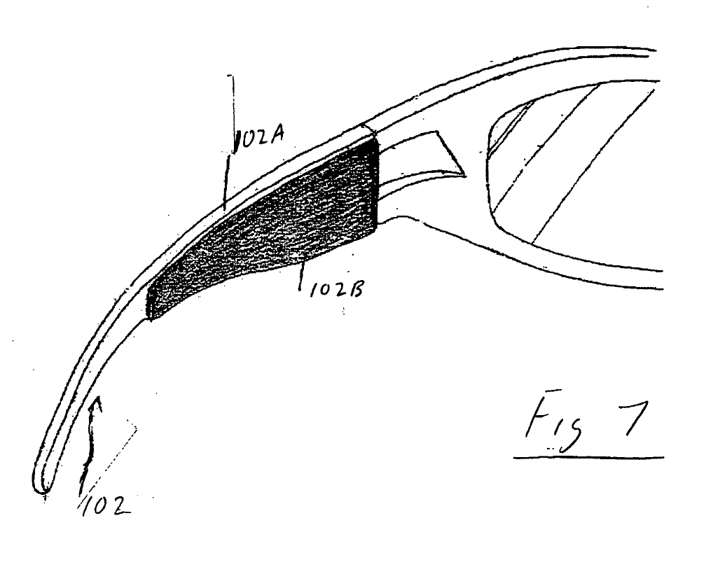

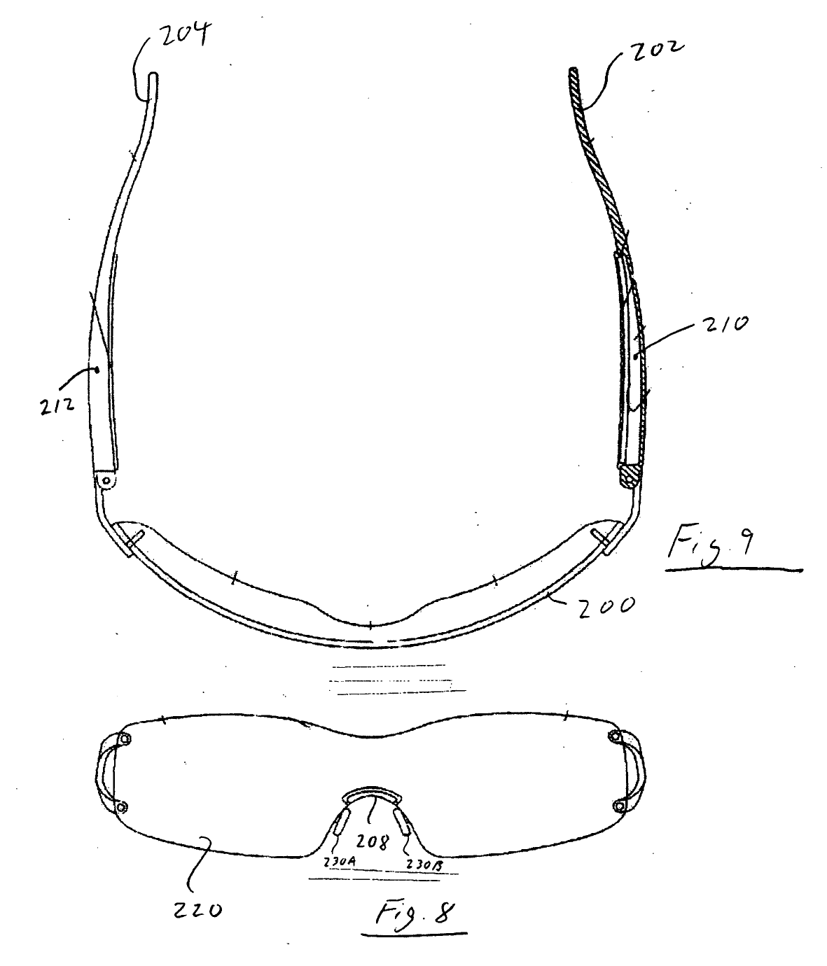

In one example (which example is intended to be illustrative and not restrictive), First Part 102A and Second Part 102B may be held together using: (a) adhesive; (b) one or more mechanical fasteners (e.g., screws with packings); (c) melting (e.g., super sonic melting); (d) any combination of the above. Referring now to FIGS. 8-12 floatable eyeglasses according to another embodiment of the present invention are shown. These eyeglasses are similar to the eyeglasses of FIGS. 1-7 in that the eyeglasses of FIGS. 8-12 likewise include Front Frame 200, Left Temple Arm 202, Right Temple Arm 204, and Bridge 208. Moreover, the eyeglasses of FIGS. 8-12 likewise include Air Chambers 210 and 212 formed in a similar manner to those of FIGS. 1-7. The main difference between these two embodiments is that the Front Frame of eyeglasses of FIGS. 8-12 is comprised of a single Lens 220 as well as Nose Rests 230A and 230B.

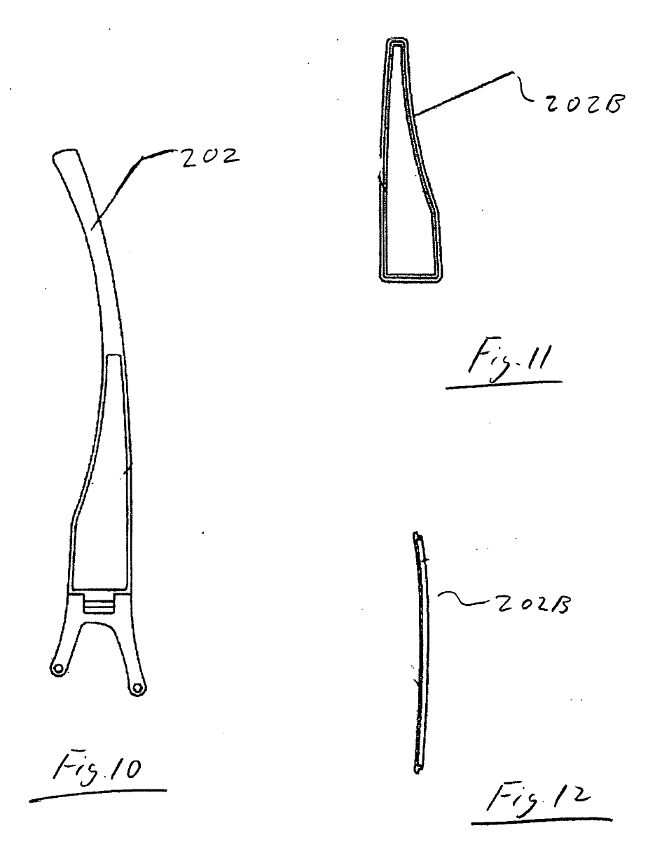

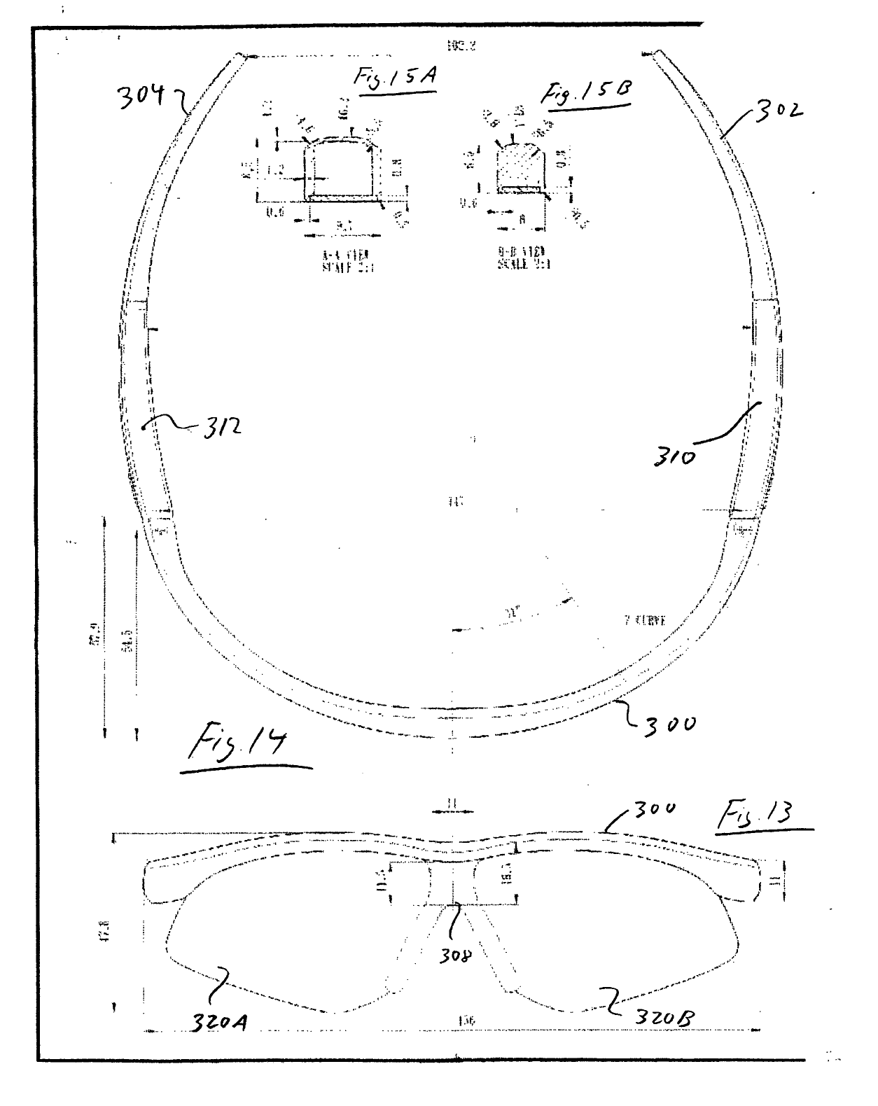

Referring now to FIGS. 13-16, floatable eyeglasses according to another embodiment of the present invention are shown. These eyeglasses are similar to the eyeglasses of FIGS. 1-7 in that the eyeglasses of FIGS. 13-16 likewise include Front Frame 300, Left Temple Arm 302, Right Temple Arm 304, and Bridge 308. Moreover, the eyeglasses of FIGS. 13-16 likewise include Air Chambers 310 and 312 formed in a similar manner to those of FIGS. 1-7. The main difference between these two embodiments is that the eyeglasses of FIGS. 13-16 include Lenses 320A and 320B attached to the bottom of Front Frame 300.

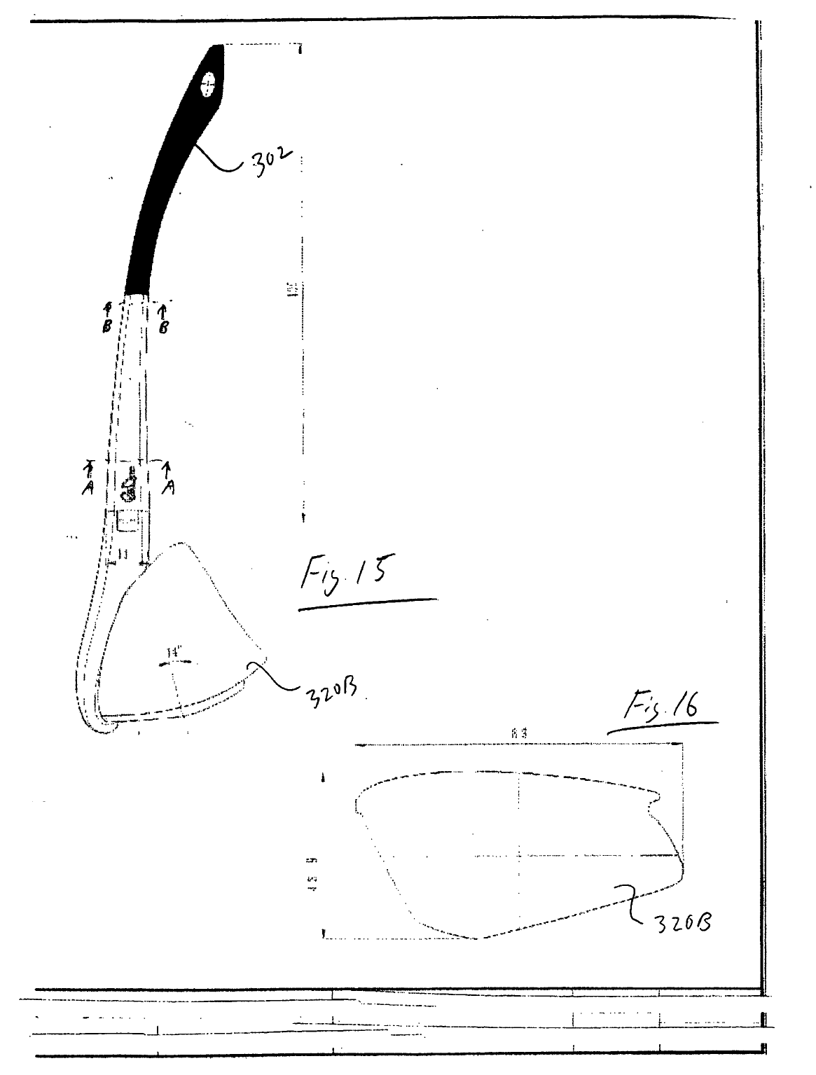

Referring now to FIG. 17, an example air chamber volume is shown (of course, this example is intended to be illustrative and not restrictive). More particularly, it is seen in this FIG. 17 that L may be about 55-58 mm, H₁ may be about 14-15 mm, H₂ may be about 7 mm and D may be about 6-8 mm. Of note, the measurements for this volume may be utilized when the weight of the eyeglasses (including lenses) is approximately 22-28 grams. Of course, other air chamber volumes may be utilized as desired (e.g., with eyeglasses of different weight).

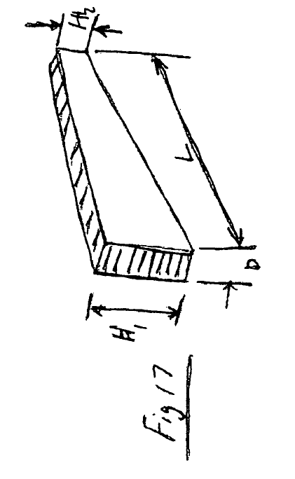

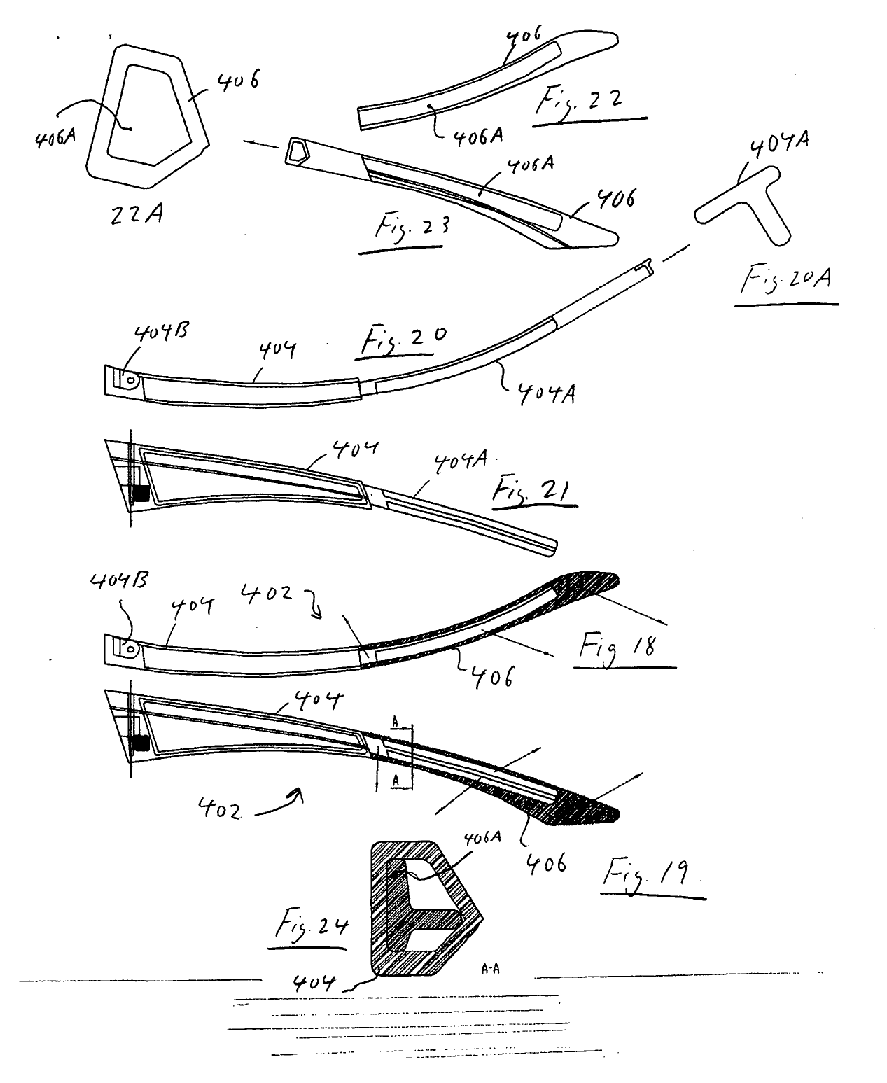

Referring now to FIGS. 18-24, temple arm construction according to another embodiment of the present invention is shown. As seen in these Figs., Temple Arm 402 comprises First Portion 404 and Second Portion 406 (First Portion 404 may attach to eyeglasses frame (not shown) via Hinge Mechanism 404B (and or via any other desired connection system)). First Portion 404 has Extension Member 404A extending therefrom and Second Portion 406 has Cavity 406A therein. Of note, Extension Member 404A is configured to be received within Cavity 406A such that First Portion 404 and Second Portion 406 mate to produce a substantially watertight compartment (or “air chamber”) in Temple Arm 402.

Of further note, while Temple Arm 402 of FIGS. 18-24 is shown as a left temple arm, a right temple arm may be similarly constructed.

In another embodiment, First Portion 404 may have the cavity and Second Portion 406 may have the extension member.

Of course, the cross-sectional configurations of the Extension Member 404A and Cavity 406A (shown, for example in FIGS. 20A, 22A and 24 may be of any desired shape.

In one example (which example is intended to be illustrative and not restrictive), First Portion 404 and Second Portion 406 may be held together using: (a) adhesive; (b) one or more mechanical fasteners (e.g., screws with packings); (c) melting (e.g., super sonic melting); (d) a friction fit between the exterior of Extension Member 404A and the interior of Cavity 406A; (e) any combination of the above.

In another example (which example is intended to be illustrative and not restrictive), the eyeglasses may comprise a material selected from the group including: (a) PC; (b) TR90; (c) any combination thereof.

In another example (which example is intended to be illustrative and not restrictive), each eyeglass lens may be less than about 2.0 mm thick.

In another example (which example is intended to be illustrative and not restrictive), the eyeglasses may be wrap-around eyeglasses.

While a number of embodiments of the present invention have been described, it is understood that these embodiments are illustrative only, and not restrictive, and that many modifications may become apparent to those of ordinary skill in the art. For example, one or more air chambers may be disposed in each of the left and right temple arms or in only one of the left and right temple arms. Further, one or more air chambers may be disposed elsewhere on the eyeglasses. Further still, the temple arms may be attached to the front frame via hinges (as shown principally in the Figs.) and/or via any other desired mechanism (e.g., the temple arms may be formed integrally with the front frame and each temple arm may fold at a flexible area). Further still, the air chambers may, of course, be filled (fully or partially) with air (and/or with any other desired gas, liquid, solid). Further still, the air chambers may, of course, be configured to contain a full or partial vacuum.

What is claimed is:

1. Floatable eyeglasses, comprising:
a first lens;
a second lens;
a frame, wherein the first lens and the second lens are mounted to the frame;
a left temple arm having at least one cavity therein;
a first cover element configured to attach to the left temple arm and cover the cavity in the left temple arm to produce a substantially watertight compartment in the left temple arm;
a right temple arm having a cavity therein; and
a second cover element configured to attach to the right temple arm and cover the cavity in the right temple arm to produce a substantially watertight compartment in the right temple arm;
wherein the left temple arm is attached to a first end of the frame; and
wherein the right temple arm is attached to a second end of the frame.

2. The eyeglasses of claim 1, wherein the substantially watertight compartment in the left temple arm and the substantially watertight compartment in the right temple arm are sized to provide, in combination, sufficient buoyancy to permit the eyeglasses to float in water.

3. The eyeglasses of claim 1, wherein the left temple arm is attached to the frame by a first hinge and the right temple arm is attached to the frame by a second hinge.

4. The eyeglasses of claim 1, wherein the first cover element is attached to the left temple arm by an attachment mechanism comprising at least one screw and the second cover element is attached to the right temple arm by an attachment mechanism comprising at least one screw.

5. The eyeglasses of claim 1, wherein the first cover element is attached to the left temple arm by an attachment mechanism comprising an adhesive and the second cover element is attached to the right temple arm by an attachment mechanism comprising an adhesive.

6. The eyeglasses of claim 1, wherein the first cover element is attached to the left temple arm by an attachment mechanism comprising melting and the second cover element is attached to the right temple arm by an attachment mechanism comprising melting.

7. The eyeglasses of claim 1, wherein the first lens and the second lens are prescription lenses.

8. The eyeglasses of claim 1, wherein the first lens and the second lens are sunglass lenses.

9. Floatable eyeglasses, comprising:
a first lens;
a second lens;
a frame, wherein the first lens and the second lens are mounted to the frame;
a first temple arm having a cavity therein;
a cover element configured to attach to the first temple arm and cover the cavity in the first temple arm to produce a substantially watertight compartment in the first temple arm; and
a second temple arm;
wherein the first temple arm is attached to a first end of the frame; and
wherein the second temple arm is attached to a second end of the frame.

10. The eyeglasses of claim 9, wherein the substantially watertight compartment in the first temple arm provides sufficient buoyancy to permit the eyeglasses to float in water.

11. The eyeglasses of claim 9, wherein the first temple arm is attached to the frame by a first hinge and the second temple arm is attached to the frame by a second hinge.

12. The eyeglasses of claim 9, wherein the cover element is attached to the first temple arm by an attachment mechanism comprising at least one screw.

13. The eyeglasses of claim 9, wherein the cover element is attached to the first temple arm by an attachment mechanism comprising an adhesive.

14. The eyeglasses of claim 9, wherein the cover element is attached to the first temple arm by an attachment mechanism comprising melting.

15. The eyeglasses of claim 9, wherein the first lens and the second lens are prescription lenses.

16. The eyeglasses of claim 9, wherein the first lens and the second lens are sunglass lenses.

17. Floatable eyeglasses, comprising:
a frame;
a first temple arm having a cavity therein;
a cover element configured to attach to the first temple arm and cover the cavity in the first temple arm to produce a substantially watertight compartment in the first temple arm; and
a second temple arm;
wherein the first temple arm is attached to a first end of the frame; and
wherein the second temple arm is attached to a second end of the frame.

18. The eyeglasses of claim 17, wherein the substantially watertight compartment in the first temple arm provides sufficient buoyancy to permit the eyeglasses to float in water.

19. The eyeglasses of claim 17, further comprising at least one lens.

20. The eyeglasses of claim 19, wherein the frame and the lens are formed as an integrated unit.

21. The eyeglasses of claim 17, further comprising a first lens and a second lens, wherein the first lens and the second lens are mounted to the frame.

22. The eyeglasses of claim 17, wherein the first temple arm is attached to the frame by a first hinge and the second temple arm is attached to the frame by a second hinge.

23. The eyeglasses of claim 17, wherein the cover element is attached to the first temple arm by an attachment mechanism comprising at least one screw.

24. The eyeglasses of claim 17, wherein the cover element is attached to the first temple arm by an attachment mechanism comprising an adhesive.

25. The eyeglasses of claim 17, wherein the cover element is attached to the first temple arm by an attachment mechanism comprising melting.

26. Floatable eyeglasses, comprising:
a first lens;
a second lens;
a frame, wherein the first lens and the second lens are mounted to the frame;
a left temple arm having a first portion and a second portion, wherein the first portion has an extension member extending therefrom and the second portion has a cavity therein and wherein the extension member is configured to be received within the cavity such that the first portion and the second portion mate to produce a substantially watertight compartment in the left temple arm;
a right temple arm having a first portion and a second portion, wherein the first portion has an extension member extending therefrom and the second portion has a cavity therein and wherein the extension member is configured to be received within the cavity such that the first portion and the second portion mate to produce a substantially watertight compartment in the right temple arm;
wherein the left temple arm is attached to a first end of the frame; and
wherein the right temple arm is attached to a second end of the frame.

27. The eyeglasses of claim 26, wherein the substantially watertight compartment in the left temple arm and the substantially watertight compartment in the right temple arm are sized to provide, in combination, sufficient buoyancy to permit the eyeglasses to float in water.

28. The eyeglasses of claim 26, wherein the left temple arm is attached to the frame by a first hinge and the right temple arm is attached to the frame by a second hinge.

29. The eyeglasses of claim 26, wherein the first lens and the second lens are prescription lenses.

30. The eyeglasses of claim 26, wherein the first lens and the second lens are sunglass lenses.

31. Floatable eyeglasses, comprising:
a first lens;
a second lens;
a frame, wherein the first lens and the second lens are mounted to the frame;
a first temple arm having a first portion and a second portion, wherein the first portion has an extension member extending therefrom and the second portion has a cavity therein and wherein the extension member is configured to be received within the cavity such that the first portion and the second portion mate to produce a substantially watertight compartment in the first temple arm;
a second temple arm;
wherein the first temple arm is attached to a first end of the frame; and
wherein the second temple arm is attached to a second end of the frame.

32. The eyeglasses of claim 31, wherein the substantially watertight compartment in the first temple arm provides sufficient buoyancy to permit the eyeglasses to float in water.

33. The eyeglasses of claim 31, wherein the first temple arm is attached to the frame by a first hinge and the second temple arm is attached to the frame by a second hinge.

34. The eyeglasses of claim 31, wherein the first lens and the second lens are prescription lenses.

35. The eyeglasses of claim 31, wherein the first lens and the second lens are sunglass lenses.

36. Floatable eyeglasses, comprising:
a frame;
a first temple arm having a first portion and a second portion, wherein the first portion has an extension member extending therefrom and the second portion has a cavity therein and wherein the extension member is configured to be received within the cavity such that the first portion and the second portion mate to produce a substantially watertight compartment in the first temple arm;
a second temple arm;
wherein the first temple arm is attached to a first end of the frame; and
wherein the second temple arm is attached to a second end of the frame.

37. The eyeglasses of claim 36, wherein the substantially watertight compartment in the first temple arm provides sufficient buoyancy to permit the eyeglasses to float in water.

38. The eyeglasses of claim 36, further comprising at least one lens.

39. The eyeglasses of claim 38, wherein the frame and the lens are formed as an integrated unit.

40. The eyeglasses of claim 36, further comprising a first lens and a second lens, wherein the first lens and the second lens are mounted to the frame.

41. The eyeglasses of claim 36, wherein the first temple arm is attached to the frame by a first hinge and the second temple arm is attached to the frame by a second hinge.
